(19) United States
(12) Patent Application Publication
(10) Pub. No.: US 2009/0164247 A1
(43) Pub. Date: Jun. 25, 2009

(54) Data and Display Protocols

(75) Inventors: Ralf Dobler, Erlangen (DE); Sven Hentschel, Bennewitz (DE); Labib Khanafer, Nurnberg (DE); Tobias Krimmer, Grossenseebach (DE); Ralf Krumtunger, Nuernberg (DE); Armin Michel, Erlangen (DE); Saket Shukla, Erlangen (DE); Thomas Stingl, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, Munchen (DE)

(21) Appl. No.: 11/962,268

(22) Filed: Dec. 21, 2007

(51) Int. Cl. G06Q 50/00; G06F 17/00

(52) U.S. Cl. 705/3

(57) ABSTRACT

The invention is related to a method and system for structuring a plurality of items of medical data in electrical form. The plurality of items of medical data is structured by a data protocol into a plurality of medical data clusters having cluster tags based on attributes of the plurality of items of medical data and the data protocol. The clustered plurality of items of medical data is used for the purpose of post processing by a plurality of post-processing modules.

### FIELD OF THE INVENTION

The present invention relates to the field of medical informatics. More specifically, the invention relates to processing of medical data in electronical form.

### BACKGROUND

The work environment for clinicians such as radiologists in medical facilities has seen a dramatic change in recent years. Computer based health information systems have been set up comprising sophisticated computer networks, storage facilities and processing modules for exchanging and processing medical data in electronical form that is in the form of computer-readable medical data files. The employment of those technologies had a vast impact on workflows as defined in those working environments. Clinical workflows in respect to medical diagnostics are particularly affected by those changes. Medical diagnostics chiefly relies on medical image data, being a special and very important type of medical data files. The medical image data is provided by modern imaging exchange systems such as Picture Archiving in Communication Systems (PACS) as part of modern radiology information systems (RIS). In medical diagnostics the radiologist mostly relies on those medical image data which is examined visually by the radiologist using modern post-processing software tools such as highly dedicated viewers. The viewers assist the radiologists in advantageously arranging vast amounts of medial image data, thus facilitating the radiologist's task of reaching the diagnosis. The medical image data is retrieved as medical image files from the PACS and normally has to undergo a structuring procedure comprising filtering/selection before the medical image files can be fed into the dedicated post-processing module, such as the viewer for viewing the medical image files on a screen or on a number of screens. The structuring of those medical image files before the actual post-processing (viewing being considered one of the most important types of post-processing) is an inevitable step in order to be able to answer a clinical question within the course of the diagnosis. For example, the radiologist who wants to answer the clinical question whether a patient's cancer proliferated over a certain period must arrange the medical image data chronologically in order to ascertain a trend in respect of the proliferation. Furthermore, the radiologist would also structure the medical image data according to the modality (for example CT-Scanning-Systems or PET-Systems) used in acquiring the medical image data to be examined. In order to facilitate the exchange of medical image data across computer systems and to make interfacing between the post-processing modules and the medical image data easier if not possible, a standard for a format of the medical image files has been adopted. This standard can also be used for structuring the medical data files. The standard is called DICOM (Digital Imaging and Communications in Medicine), prescribing defined meta-data to be embedded as header file information into the medical image files. The meta-data is expressed as so called DICOM attributes having values and, the DICOM attributes describing the content of the medical image file. Examples of DICOM attributes are information pertaining to a patient like the patient's name or ID, information pertained to “study date”, “study time” (including the date and time on and at which the medical image file has been acquired), the modality type, the modality type describing the type of equipment used in acquiring the medical image file (for example a CT scanning system or a PET system).

Some of the current viewers used by radiologists for visually examining the medical image data access those DICOM attributes of the medical image files in order to structure the medical image files as defined by the radiologist. Examples of such viewers are 3D viewers for arranging slices into volumes such as to create a 3D image. Most of the viewers however do not use the DICOM attributes for structuring, but rather take the DICOM attributes at “face value” and display the DICOM attributes along with the image proper as if the DICOM attributes would belong to the image proper, the image proper being a part of the medical image file.

In some of the current systems, the structuring is defined in terms of so called “hanging protocols”, more particularly in terms of “DICOM hanging protocols” (DICOM HP), TICOM HPs are electronical data files in which rules are encoded for structuring and displaying the medical image data based on the DICOM attributes such that, upon interfacing of the viewer with the DICOM HP, the medical image files are automatically selected and arranged by the viewer for display according to rules on a screen.

However, currently there are few viewers using a standard for display given by the DICOM HP, and most of those viewrs using the DICOM HP for structuring and displaying the medical images files allow for defining merely a 2-level hierarchy for structuring in term of Image Sets and Display Sets.

There are however a number of other drawbacks with this approach.

First, current methods for structuring, including the use of DICOM HPs, are restrictive in that they only allow structuring the medical image data into at most a 2-level hierarchy. Furthermore, in DICOM HPs the rules for defining the structuring, such a filter and selection rules, have a limited syntax. Only disjunctive (OR) or conjunctive (AND) combinations on the DICOM attributes are allowed.

Second, DICOM HPs must be edited by the radiologist or someone having a high level of radiological knowledge. This is because for this editing task the medical knowledge of the radiologist is required in order to define meaningful structurings for diagnostic purposes. Furthermore, in order to define the DICOM HP, an expert knowledge of DICOM specific semantics and syntax for the rules are required. Very powerful UIs (user interfaces) are needed in order to enable a non-specialist in DICOM matters editing a non-trival DICOM HP. The radiologist is a medical expert and not an IT administrator, and hence does not normally have the DICOM knowledge at the required level. The IT administrator on the other hand lacks the medical knowledge.

Third, in current post processing modules however, the structuring is done manually by the radiologist, as most of the current post-processing modules allow for a default structuring only, which may not be suitable for a specific clinical question within the examination. This default structuring usually provides only for a simple, fixed hierarchy according to, for example, the DICOM attributes for the patient's ID, the study name, a medical image series attribute and the actual medical image ID attribute. The structuring according to this default hierarchy however bears in general little if any relevance to the clinical question at hand.

Fourth, different viewers and other post/processing modules normally require dedicated HPs, especially adapted to those viewers and post/processing modules—reusing parts of an existing DICOM HP by an array of different post/-processing modules is currently not possible. For example having a post-processing tool selectively access only those rules in the existing DICOM HP that refers to the displaying rather then the structuring of the medical image files is currently not possible.

There is therefore a need in the art to ease the burden on the radiologist and freeing him or her from the time-consuming and tedious task of becoming versed in DICOM and editing DICOM HPs.

There is a further need to structure a plurality of the medical image files in a way, such as to make the plurality of the structured medical image files available for reuse by other post processing modules including but not limited to viewers, such that, eg, the structured medical image files can be displayed differently by each of the viewers if so desired.

Furthermore, it would be advantageous to have methods at hand that certain specifics of the structuring are automatically and dynamically determined based on the DICOM attributes of the medical image files to be structured. For example, if the structuring is based on clusters, the specifics would pertain to the number of clusters into which the medical image files are to be clustered, or to how many hierarchy levels the clustered medical image files are to be arranged

### SUMMARY OF THE INVENTION

One aspect of the present invention addresses these needs by providing a method for structuring a plurality of items of medical data by means of a data protocol for post processing the items of medical data. The post processing is executed by a plurality of post processing modules and the items of medical data have attributes. The method comprises:

Receiving the plurality of items of medical data to be structured;

Applying the data protocol through the received plurality of items of medical data; and

Structuring the plurality of items of medical data into medical data clusters. The medical data clusters have cluster tags and the clustering and the cluster tags are based on the attributes of the items of medical data and the applied data protocol.

Structuring the items of medical data facilitates post processing. Once structured, the structured plurality of items of medical data can be made available to the plurality of post processing modules. The workload on the post processing modules has thus been lessened as the post processing modules no longer have to structure the items of medical data before commencing with the actual post-processing, such as displaying the items of medical data. Furthermore, radiologist no longer have to deal with structuring issues, but are enabled to fully concentrate on clinically relevant issues of the medical data, such as, for example, how best to display the medical data if the medical data are given a medical image data. Structuring may be construed as physical structuring or “virtual” that is logical structuring (non-physical).

The term “medical data” or “items of medical data” as used in this disclosure should be interpreted to mean medically relevant data in electronical form. More specifically, the items of medical data are computer readable data file, comprising image and text information. Examples are medical images such a volumes and medical image files such as slices acquired from, for example, a CT or X-ray modality or medical reports.

The “attributes” of the items of medical data should be interpreted to pertain to meta-data describing the content within the items of medical data. For example: If the items of medical data are taken to be image files acquired from the CT modality by scanning a patient's chest, the attributes of this image files can be reasonably expected to comprise: The patient's name and ID, an acquisition time of the image file (also called study date and study time), information about the modality, in this case CT, and information pertaining to the image itself, such as resolution information of the pixel data and photometric information.

“Structuring” of the items of medical data should be construed broadly. It includes arranging the items of medical data into a suitable data structure, such as clusters and groups. The structuring might occur before the post processing of the items of medical data to produce a permanent data structure representing the structured items of medical data, for example, suitably arranged directories in a computer system or associative arrays or interlinked tables of a relational database management system (RDBMS). The structuring might be also thought of as occurring “on the fly” with respect to post processing the items of medical data. In this case, the “data structure” representing the structured plurality of items of medical data would not be stored as a permanent data structure. The data structure would rather be memory resident before being pipelined into or passed on, by way of a suitable interface, to one or more of the plurality of the post processing modules for post processing.

By “clusters” into which the plurality of items of medical data are structured is meant either a physical or logical grouping of the plurality of items of medical data. Medical clusters are physical, if multiple items of medical data that share the same or an equivalent attribute are moved and saved or stored at the same location within the computer system, for example a dedicated directory. According to a preferred aspect of the present invention, however, the clusters are logical clusters. The ones of the plurality of the items of medical data sharing the same or equivalent attributes are not thought to be moved to some dedicated location. For the purposes of the invention, it is sufficient to have IDs for each one of the plurality of items of medical data (for example URLs or other locator or reference means) and to associate the IDs of those items of medical data that are to be structured into the same logical medical cluster with the same cluster tag. The cluster tags are IDs in the form of alphanumeric strings that are used to identify each one of the medical clusters. Preferably, the cluster tags are strings indicative to clinically relevant names, such that the radiologist understands the meaning of the tags and thus has an idea about the items of medical data within the cluster. A cluster tag ‘CT’ would obviously indicate a cluster comprising all the medical image files of a patient acquired by means of a CT modality.

The term “data protocol” according to the present invention is a file into which is encoded, for example by means of a suitable protocol language (for example a mark-up language such as XML), rules and conditions for and on the attributes of the items of medical data. Those ones of the items of medical data having attributes that comply with those rules and conditions are thought to be structured into the same medical data cluster. Furthermore, the data protocol can also encode information about relationships (such as hierarchies) between the medical data clusters, into which the plurality of items of medical data is supposed to be structured. The data protocol may also contain information about post-processing or post processing modules relevant to the items of medical data within the specific medical cluster.

By “receiving” is meant any means and measures for making available the plurality of items of medical data for structuring by push or pop operations. A simple example for receiving would be to have the items of medical data transmitted as a data stream within the computer network. Another example according to a preferred aspect of the present invention is the reception of a list comprising the IDs or URLs of each one of the items of medical data with each ones of the IDs being associated with all the attributes of the respective file the Ids are referring to.

The term “applying the data protocol” should be construed as measures to put the structuring into the medical clusters into effect. Typically, the application of the data protocol to the items of medical data comprises filtering the attributes of the received items of medical data by, for example, matching a specific attribute expressed as an alphanumeric stream against another alphanumeric stream expressed in the rules and conditions within the data protocol. Furthermore, the application of the data protocol comprises selecting the filtered ones of the items of medical data. The selection can be put into effect, for example, by associating the IDs of the filtered ones of the items of the medical data by the cluster tag of the medical data cluster into which the filtered ones of the items of medical data are supposed to be structured according to the data protocol. The data protocol is applied sequentially to the plurality of items of medical data, one by one. However, as an alternative aspect of the present invention, other modes of application may be used.

According to one aspect of the present invention, the kind and/or number of the medical clusters is automatically and dynamically adaptable based on the attributes of the plurality of items of medical data. Thus, the kind and/or number of medical data clusters does not have to be known in advance, that is before reception of the items of medical data. By suitable conditions (for example looping and tracking constructions) encoded into the data protocol, it is ensured that, upon detection of an attribute hitherto undetected within those ones of the items of medical data to which the data protocol has been already applied to, a new medical data cluster is defined. This new medical data cluster is the medical data cluster into which the items of medical data having this hitherto undetected attribute are structured.

According to yet another aspect of the present invention the medical clusters are arranged in a hierarchy. The hierarchy has a number of hierarchy levels. The number of hierarchy levels is also automatically and dynamically adaptable and is based on the attributes of the plurality of items of medical data.

By allowing structuring of the items of medical data into the hierarchy of medical clusters facilitates obtaining medical information for the purposes of diagnosis. More specifically, information embedded within the plurality of the items of medical data as a whole is easier to obtain.

According to yet another aspect of the present invention, the method further comprises:

Interfacing between the clustered plurality of items of medical data and the plurality of post processing modules. The interfacing is effected by making available to the plurality of post processing modules ones of the plurality of items of medical data from selected ones of the medical data clusters. More particularly, if a specific type of post processing concerns only certain ones of the items of medical data within specific medical data clusters, the post processing modules can selectively access the ones of the items of medical data within those specific medical data clusters.

According to yet another aspect of the present invention one of the plurality of those post-processing modules is a display module and the method further comprises:

Applying the clustered plurality of items of medical data to a display protocol using the cluster tags;

The post processing comprises displaying the plurality of items of medical data on a graphics display by means of the display module. The displaying is effected by arranging a selection of the plurality of medical data as segments on a graphic display. The arranging of the selected ones of the plurality of the medical data is based on the cluster tags of the medical data clusters and the display protocol.

By applying to the clustered plurality of the items of medical data, in a separate step, the display protocol which is different from the data protocol, a separation of concerns with respect to the post processing of the items of medical data is put into place. Thus, aspects concerning structuring the items of medical data have been encapsulated into the data protocol. Other aspects relating solely to the displaying of the items of medical data (displaying being a special type of post processing) are fully encapsulated into the display protocol. Furthermore, a data abstraction has been implemented, the cluster tags being such an abstraction from the attributes. Rules and conditions within the display protocol are expressed in terms of cluster tags only. The display protocol is thought to reference the data protocol and according to one aspect of the present invention, the same data protocol can be referenced by a number of different display protocols. In fact, according to an alternative aspect of the present invention, the application of a series of “post-processing protocols” to the items of medical data for post processing purposes is contemplated. According to this aspect, the data protocol is thought to be the first protocol in this series of protocols referenced by the second post processing protocol, which in turn is then referenced by the third post processing protocol within the series of post processing protocols.

The data protocol addresses general structuring needs in expressing rules and conditions relevant for general structuring in respect of the medical data. The other protocols in the series on the other hand address more specific aspects, such as expressing rules and conditions relevant for displaying the medical data in case of the display protocol, the display protocol being a special post-processing protocol or one of a number of different display protocols, each one of the different display protocols being most suitable for a context of a specific clinical questions. The data abstraction as given by the series of post-processing protocols allows for accounting for those specific needs arising in the various post-processing steps. Structuring for example is non-user and non-context specific, whereas displaying is normally user- and context specific, the context being given by the specific clinical question asked during the displaying step or other post-processing step.

Another aspect of the present invention addresses these needs by providing a computer readable medium, having computer-executable instructions for performing a computer-implemented method for structuring a plurality of items of medical data by means of a data protocol for post processing the items of medical data by a plurality of post processing modules. The items of medical data have attributes and the method comprises:
receiving the plurality of items of medical data to be structured;
applying the data protocol to the received plurality of items of medical data; and
structuring the plurality of items of medical data into medical data clusters having cluster tags for post processing the plurality of medical data. The clustering is based on the attributes and the applied data protocol; and
interfacing between the clustered plurality of items of medical data and the plurality of postprocessing modules by making available to the plurality of post-processing modules ones of the plurality of items of medical data from selected ones of medical data clusters.

Yet, another aspect of the present invention addresses these needs by providing a system for structuring a plurality of items of medical data by means of a data protocol. The structuring is executed for the purpose of post processing the items of medical data by a plurality of post processing modules, the items of medical data having attributes. The system comprises:
a data storage device, storing the plurality of items of medical data to be structured;
a data storage interface for receiving the plurality of items of medical data to be structured;
a cluster manager module for applying the data protocol against the received plurality of items of medical data and structuring the plurality of items of medical data into medical data clusters having cluster tags, the clustering being based on the attributes and the applied data protocol; and
a post-processing interface for interfacing between the clustered plurality of items of medical data and the plurality of post-processing modules by making available to the plurality of post-processing modules ones of the plurality of items of medical data from selected ones of medical data clusters.

One of the plurality of post-processing modules is a display module and the system further comprises:
a display manager module for applying the clustered plurality of items of medical data to a display protocol using the cluster tags.

According to another aspect of the present invention, the display module displays the plurality of items of medical data by arranging a selection of the plurality of medical data as segments on a graphics display. The arranging of the selected ones of the plurality of medical data is based on the cluster tags of the medical data clusters and the display protocol.

Yet, another aspect of the present invention addresses these needs by providing an interface arranged to interface between a post-processing module from a plurality of a post-processing modules and a plurality of items of medical data clustered into medical data clusters having cluster tags. The interface makes available ones of the plurality of items of medical data from a selection of the medical data clusters, the selection being based on the cluster tags.

### BRIEF DESCRIPTION OF THE DRAWINGS

FIG. 1 is a schematic block diagram illustrating basic components of the system for structuring items of medical data based on the data protocol according to one aspect of the present invention.

FIG. 2 is a flow chart the method for structuring the items of medical data according to one aspect of the present invention.

### DETAILED DESCRIPTION

In the following detailed description of the preferred embodiments, reference is made to the accompanying drawings which form a part hereof, and in which are shown by way of illustration of specific embodiments in which the invention may be practiced. It is to be understood that other embodiments may be utilized and structural changes may be made without departing from the scope of the present invention.

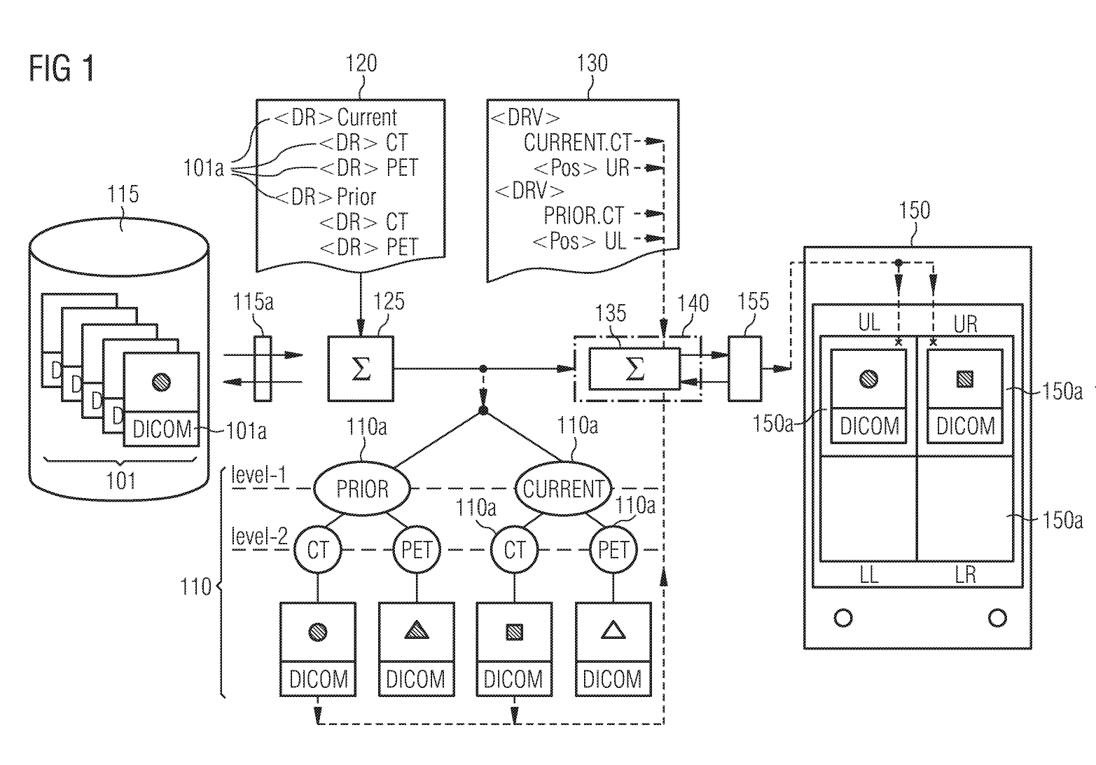

FIG. 1 shows a system according to one aspect of the present invention for structuring items of medical data 101 by means of a data protocol 120 for the purposes of post processing the so structured items of medical data 101 by a plurality of data processing modules. It should be understood that FIG. 1 merely shows an exemplary system for structuring the items of medical data 101. FIG. 1 therefore shows just one post processing module of a particular type. The post-processing module is a display module 155 arranged to display the items of medical data 101 on the graphics display 150 (for example a monitor or a number or synchronized monitors), once items of medical data 101 have been structured. However, it should be understood that in a real working scenario within a medical facility there a likely to be a number of different special purpose post processing modules, each one of accessing (in various access modes, ether independently or sequentially) the items of medical data 101 after they have been structured.

Before going into the details of the operation of the system illustrated by FIG. 1, a broad overview of the components of the system shall be given. The items of medical data 101 to be structured reside in a data storage device 115. The items of medical data 101 are stored as electronical files. The expressions “items of medical data” 101 or “medical data files” or “medical image files” shall be used inter-changeably in the following description. A cluster manager module 125 interfaces via a data storage interface 115a with the data storage device 115 in order to receive the medical data tiles 101. Meta-data describing the content within the medical data files 101 are embedded into the medical data files 101. If the medical data files 101 are stored in the well known DICOM format, then the meta-data is encoded as DICOM attributes 101a which are embedded as header data into the medical data files 101. The cluster managing module 125 applies a data protocol 120 to the DICOM attributes 101a from the medical data files 101. The application of the data protocol 120 by the cluster manager module 125 results in the medical data files 101 to be structured into a number of data clusters 110 as defined in the data protocol 120. Each cluster is preferably given a descriptive cluster tag 110a according to definitions in the data protocol 120. As a further result of the structuring procedure, that is as a further result of applying the data protocol 120 to the medical data files 101, the medical data clusters 110 are arranged in an exemplary 2-level hierarchy. In a medical context, the medical data clusters 110 are referred to as data roles (<DR>) and the cluster tags 110a as data role names. The two terms “data role names” and “data roles” will be used interchangeably for the terms “medical data clusters” 110 and “cluster tags” 110a, respectively. Once the medical data files 101 have been arranged into data roles 110 the medical data files 101 are ready to be selectively accessed by any one of a plurality of post processing modules for post processing purposes. The access is selective, as the post-processing modules interface with the medical data files by connecting to a pre-selected number of the data roles 110 and thus only access the medical data files 101 in the pre-selected data roles 110. A special post-processing module, as been mentioned above, is depicted in FIG. 1 as the display module 155 suitable for displaying the medical data files on the monitor 150. One example of the display module 155 is a file viewer. A post processing interface 140 is arranged for interfacing between the display module 155 and the structured medical data files 101 using the data roles 110. The post processing interface 140 comprises a display managing module 135, although the display managing module 135 could also be a separate module interfacing with the post processing interface 140. The way or mode in which a radiologist wishes the image files 101 to be displayed on the graphics display 150 is defined in the display protocol 120. The display module 155 accesses a selection of the medical image files 101. More particularly, the image files 101 to be accessed are specified by the means of the data roles 110 and the data role names 110a. The display protocol 120 is applied to the structured medical image files 101 by the display manager module 135. The display protocol 120 specifies by means of the data role names 110a which display related parameters (such as layout, positioning of the image data files 101 on the graphics display 150, etc.) are to be applied to the medical image files 101 within the selected date roles 110. In the example of FIG. 1, the display protocol 120 prescribes an image file that has been assigned to the data role having the data role name “CURRENT.CT” to be displayed on a “(U)pper (R)ight” hand segment 150a of the graphics display 150 as indicated by the string “UR” in display protocol 130. As can be seen, the particular data role “CURRENT.CT” is a (sub)-data role arranged in the level-2 hierarchy of all data roles 110. The arrangement is indicated by the familiar “dot” notation for defining paths in hierarchical data structures with the data role name 110a “CURRENT.CT”. The data role 110 with this name is holding the most recent (CURRENT) one(s) of the medical image files 101 that have been acquired from a CT modality (CT).

Other post processing modules may require a suitably adapted post-processing interface 140 suitable to apply or to interface with a corresponding “post processing protocol”. In general, the data protocol 120 is referenceable from a number of different display protocols 130 (or more generally post processing protocols), each one of the display protocols corresponding to a specific display mode adapted to a specific diagnostic task or group of task.

According to an alternative aspect of the present invention the post processing of the medical data files 101 is effected by a series of post processing modules each one of the post processing modules within the series post-processing the medical data files 101 according to a different post processing protocol applied by corresponding manager modules and post-processing interfaces 140. In this “serial” scenario the post-processed medical data files 101 can be thought to be pipelined from a previous one of the post processing modules within the series to a next one of the post processing modules. The structuring of the medical data files 101 is in fact separated from the post processing of the medical data files 101 by applying first the data protocol 120 and then one or more post processing protocols (for example the display protocol 130). In this way, a separation of concerns in respect of structuring and post processing is established.

The task of structuring is completely encapsulated in the data protocol 120, whereas the task of post processing (for example displaying the image data files 120) is completely encapsulated in the display protocol 130, the display protocol 130 being a special type of post processing protocol.

Each of the protocols furthermore implements a data abstraction. The data roles 110 (the medical data clusters) and their respective data roles names 110a are an abstraction from the DICOM attributes from the image data files 101 to be structured. The data role views (expressed as <DRV> in the display protocol 130 of FIG. 1) are defined in the display protocol 130 and are used to express the application of the display related parameters on the other hand are an abstraction from the data roles 110.

This instance of a separation of concern is particularly useful for medical purposes in that it helps define efficient work flows within the medical facilities. More particularly, the workflow for obtaining a diagnosis based on medical data files 101 can be looked at as including a number of phases.

In one phase, an IT-Administrator in the medical facility can be entrusted with the task of editing a data protocol 120 used for structuring the medical data files 101 residing in the data storage device 115. This task requires a great deal of DICOM specific knowledge in order to draft the data protocol 120 in a suitable mark-up language. The IT-Administrator expresses rules and conditions (not shown in FIG. 1) with which the DICOM attributes have to comply with in order to be assigned to the same data role 110. For this task, on the other hand only little medical knowledge is required. The radiologist on the other hand uses his or her medical knowledge in editing for example the display protocol 130 where he defines conditions and rules for specific display related parameters to be applied to the medical image files 101 within specific data roles 110. To do so, the radiologist expresses these rules and conditions exclusively in terms of data roles names. In this way, the radiologist is shielded from having to deal with DICOM semantics and can fully concentrate on display issues. The radiologist's task is hence a purely medical one. The radiologist can define with ease suitable display protocols 130 for specific diagnostic purposes.

In the following a more detailed description of the operation of the data cluster manager module 125 and the display manager module 135 is given. The operation of the display manager module 135 is similar to the operation of the cluster manager module 125. The explanation will therefore focus on the operation of the cluster manager module 125.

The data protocol 120 is applied to the DICOM attributes 101a from the medical data files 101 by means of the cluster manager module 125. The application of the data protocol 120 comprises matching of DICOM attributes 110a values against patterns expressed in a mark-up language (for example XML). The application further comprises a selection of those medical data files 101 whose DICOM attributes 101a values match the patterns. The matching of patterns against values of DICOM attributes 101a should be construed broadly as it may also include some calculations to be performed involving some of the values of the DICOM attributes 101a. Structuring the medical data files 101 into the two data roles 110 shown in FIG. 1, having the data role names 110a “PRIOR” and “CURRENT”, respectively, involves the calculation using the value of the DICOM attributes 101a “STUDY DATE”. This value indicates the acquisition time of the respective medical data file 101. The cluster managing module 125 fetches a current system time of the computer system implementing the cluster managing module 125. It then calculates into which one of pre-determined time intervals, reckoned backwards from the acquired current system time, the value of the “STUDY DATE” DICOM attribute 101a happens to fall. In this way, the medical data files 101 can be clustered into two level 1 clusters, the clusters being assigned the data role name “CURRENT” and “PRIOR”. If, for example, the intervals are measured in weeks, then all medical data files 101 that have been acquired within a week's time reckoned from the local system time will be assigned to the data role 110 having the data role name 110a “CURRENT”. Medical data files 101 having “STUDY DATE” DICOM attribute value indicative to a time pre-dating this week, will be correspondingly assigned to data role 110 having the data role name 110a “PRIOR”. Clustering the medical data files 101 into data roles 110 indicative to the modality with which the respective medical data files 101 have been acquired requires just a simple pattern matching of a value of the DICOM attribute 101 “MODALITY TYPE”. In this case the cluster managing module 125 simply matches the DICOM attribute 101a values against the string “CT” in order to assign all those medical data files 101 into the data role 110 having the data role name “CT”. As shown in FIG. 1, the modality type data role 110 is a level 2 data role which means that in general there will be two “CT” modality type data roles each one being a sub cluster of sub data role of the two study time data roles 110. Exemplary data roles 110 in FIG. 1 therefore show in total 6 data clusters arranged in a two level hierarchy. Data cluster manager 125 structures the medical data files 101 according to the rules expressed in the data protocol 120. The example in FIG. 1 the rules with respect to hierarchies are expressed by corresponding indentations of the data role markers ‘<DR>’.

According to one aspect of the present invention, the data cluster module 125 is arranged to automatically and dynamically adapt the number and (applicable) kind of hierarchy levels. The data cluster manager 125 keeps track of the generated data roles 110 while applying the data protocol 120 against the medical data files 101 and loops each one of the DICOM attributes 101a through the tracked data roles 110. If the data cluster manager 125 comes across DICOM attribute 101a value have not been tracked so far, it automatically generates a new data role 110 within the right hierarchy level, using the rules as described in the data protocol 120. In this way not only the number of the data roles 110 but only their hierarchy positions are automatically and dynamically adapted. The total number of the data roles 110 and their hierarchical relationship does not have to be known beforehand, making the application of the data protocol 120 dynamically adapting to the medical data files 101 to be structured. Once the data protocol 120 has been drafted, there is no further intervention on the part of the radiologist needed. The procedure implemented by the system for structuring the medical data files is hence automatic.

The display managing module 135 works along the same principles when applying the display protocol 130 against structured medical data files 101. The display managing module 135 uses the data role names 11a to selectively access the medical data files 101 within the data roles 110 having those names. The display manager can therefore selectively apply the parameters relating to the way in which those medical data files 101 should be displayed. Display module 155 fetches the medical data files 101 from those data roles 110 and applies the display related parameters as described in the respective data role view (<DRV>) within the display protocol 130. The data role view is just one of those display related parameters. The data role views assign the data roles 110 from the data protocol 120 to specific segments 150a on the graphic display 150. This causes medical data (images) files 101 from the assigned date roles to be displayed in those segments 150a of the graphics display 150. The display protocol 130 further prescribes for each data role view a sort order, other visualisation parameters (VRT, MPR) and a synchronisation parameter across the data role views. Other display related parameters define display environment (that is the number of types of screens and the orientation as well as the resolution, best suited to the specific display protocol 130) and viewing layouts.

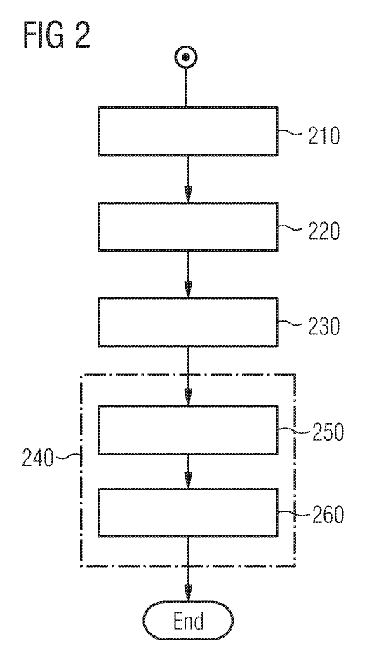

FIG. 2 shows a flowchart of the method according to the present invention for structuring medical data files 101 into data roles 110. The method comprises the steps of receiving 210 the medical data files 110 either as a data stream or as a list of locators each locator having attached or being associated with DICOM attributes 110a and a value for each one of those medical data files 110 referred to by the locator.

In step 220 the cluster managing module 125 applies the data protocol 120 to the DICOM attributes 110a of each of those medical data files 101. The application of the data protocol 130 comprises matching DICOM attributes 101a as prescribed by the rules and conditions within the data protocol 130. Depending on the outcome of the application of the data protocol 130, the medical data files 101 are structured in step 230 in the plurality of data roles 110 (medical data clusters) each one of the data roles being given data role names (cluster tags) 110a, the data role names 110a being prescribed by the data protocol 130.

In step 240 the plurality of post processing modules interface 240 with the structured medical data files 101. The interfacing 240 is effected by making available to the plurality of post processing modules a selection of the plurality of medical data files 101 for the purposes of post processing the medical data files 101. The Post processing modules are selectively accessing medical data files 101 by connecting to ones of the data roles 110. When the post processing involves displaying medical data files 101, displaying being a special type of post processing, the step of interfacing 240 comprises at least two further steps. Step 250 applies a special post processing protocol, a display protocol 130, to the structured items of medical data files 101, the application of the display protocol 130 being based on the data role names 110a. In step 260 the medical data files 101 are displayed using a display module 115 interfacing with the graphics display 150 by arranging the selection of the medical data files 101 as segments 150a on the graphics display 150. The Selection is effected by connecting only to those data roles 110 as prescribed in the display protocol 130 in terms of the date role names 110a. The arranging is effected by applying the parameters as prescribed by the data role views within the display protocol 130.

It is to be understood that the above description is intended to be illustrative, and not restrictive. Many other embodiments will be apparent to those of skill in the art upon reviewing the above description. For instance, in one embodiment described above,

The scope of the invention should, therefore, be determined with reference to the appended claims, along with the full scope of equivalents to which such claims are entitled.

1.-11. (canceled)

12. A method for structuring a plurality of items of medical data by a data protocol in order to post process the plurality of items of medical data by a plurality of post-processing modules, comprising:
receiving the plurality of items of the medical data;
applying the data protocol to the plurality of items of medical data; and
clustering the plurality of items of medical data into a plurality of medical data clusters having cluster tags based on attributes of the plurality of items of medical data and the data protocol.

13. The method as claimed in claim 12, wherein a number of the medical clusters is automatically and dynamically adapted based on the attributes of the plurality of items of medical data.

14. The method as claimed in claim 13, wherein the plurality of medical data clusters are arranged in a hierarchy having a plurality of hierarchy levels.

15. The method as claimed in claim 14, wherein a number of the hierarchy levels is automatically and dynamically adapted based on the attributes of the plurality of items of medical data.

16. The method as claimed in claim 15, further comprising interfacing between the plurality of items of medical data clustered in the plurality of medical data clusters and the plurality of post-processing modules.

17. The method as claimed in claim 16, wherein the plurality of post-processing modules selectively access one of the plurality of items of medical data within a specific medical data cluster selected from the plurality of medical data clusters.

18. The method as claimed in claim 12, wherein one of the plurality of post-processing modules is a display module.

19. The method as claimed in claim 18, further comprising:
applying the plurality of medical data clusters to a display protocol using the cluster tags, and
displaying the plurality of items of medical data clustered in the plurality of medical data clusters by the display module by selecting the plurality of items of medical data as segments on a graphics display based on the cluster tags and the display protocol.

20. The method as claimed in claim 12, farther comprising storing the plurality of medical data clusters.

21. A computer readable medium comprising computer executable instructions for structuring a plurality of items of medical data by a data protocol in order to post process the plurality of items of medical data by a plurality of post-processing modules, comprising:
receiving the plurality of items of medical data;
applying the data protocol to the plurality of items of medical data;
structuring the plurality of items of medical data into a plurality of medical data clusters having cluster tags based on attributes of the plurality of items of medical data and the data protocol; and
interfacing between the plurality of items of medical data clustered in the plurality of medical data clusters and the plurality of post-processing modules.

22. A system for structuring a plurality of items of medical data by a data protocol in order to post process the plurality of items of medical data by a plurality of post-processing modules, comprising:
a data storage device that stores the plurality of items of medical data;
a data storage interface that receives the plurality of items of medical data;
a cluster manager module that applies the data protocol to the plurality of items of medical data and clusters the plurality of items of medical data into a plurality of medical data clusters having cluster tags based on attributes of the plurality of items of medical data and the data protocol; and
a post-processing interface that interfaces between the plurality of items of medical data clustered in the plurality of medical data clusters and the plurality of post-processing modules.

23. The system as claimed in claim 22, wherein one of the plurality of post-processing modules is a display module.

24. The system as claimed in claim 23, wherein the plurality of items of medical data clustered in the plurality of medical data clusters is applied to a display protocol using the cluster tags.

25. The system as claimed in claim 24, wherein the display module displays the plurality of items of medical data by selecting the plurality of items of medical data as segments on a graphics display based on the cluster tags and the display protocol.

26. The system as claimed in claim 22, wherein the plurality of post-processing modules selectively access one of the plurality of items of medical data within one of the medical data clusters selected based on the cluster tags via the post-processing interface.
